(19) United States
(12) Patent Application Publication
(10) Pub. No.: US 2009/0134101 A1
(43) Pub. Date: May 28, 2009

(54) FILTRATION SYSTEM

(76) Inventor: Dae Sung Lee, Staten Island, NY (US)

Correspondence Address: GREENBERG TRAURIG, LLP, 200 PARK AVE., P.O. BOX 677, FLORHAM PARK, NJ, 07932, US

(21) Appl. No.: 12/304,889

(22) PCT Filed: May 2, 2008
(86) PCT No.: PCT/US08/62333

§ 371 Date: Dec. 15, 2008

Related U.S. Application Data
(60) Provisional application No. 60/927,345, filed on May 3, 2007.

(51) Int. Cl. B01D 24/46

(52) U.S. Cl. 210/774; 210/177

(57) ABSTRACT

A filter comprising a filter element with a filtering medium, mounted in a housing having a first end and a second end, and a passageway A removable generator to provide heated fluid for regenerating the filter element is to be connected to the housing adjacent the second end The second end of the filter element is constructed so as to permit a first portion of the heated fluid to flow toward the first end of the filter element, and the passageway is to allow a second portion of the heated fluid to flow from the second end to the first end, bypassing the filtering medium A flow director is positioned adjacent to the first end of the filter element for directing the second portion of the heated fluid discharged from the passageway toward the first end of the filter element.

### CROSS-REFERENCE TO RELATED APPLICATION

This application claims the priority of U.S. Patent Application Ser. No. 60/927,345 filed May 3, 2007, the disclosure of which is incorporated herein by reference in its entirety for all purposes.

### TECHNICAL FIELD OF THE INVENTION

The present invention relates to filtration systems, and, more specifically, to regenerable filtration systems.

### BACKGROUND ART

Filters are used to remove particulates and/or other undesirable substances (e.g., toxins, bacteria, etc.) from fluid passing therethrough. When filters become clogged with such substances, they lose their effectiveness and therefore need to be either replaced or regenerated. For example, U.S. Pat. Nos. 5,277,828 and 6,063,272 disclose regenerable filters. While the filters disclosed in these patents utilize a flow of heated fluid for regeneration purposes, there is still a need for filters which can be effectively regenerated by heat in an energy-efficient, convenient manner.

### DISCLOSURE OF THE INVENTION

In accordance with an embodiment of the present invention, a filter includes a housing and a filter element, which is mounted in the housing and has a first end and a second end. The filter element has a filtering medium therein between the first and second ends and a passageway extending therethrough between the first and second ends. The filter is further provided with a generator sized and shaped so as to be connected to the housing for introducing a heated fluid to the housing adjacent the second end of the filter element for regenerating the filter element. The second end of the filter element is constructed so as to permit a first portion of the heated fluid to pass therethrough and flow toward the first end of the filter element, while the passageway is constructed so as to allow a second portion of the heated fluid to flow from the second end of the filter element to the first end of the filter element without passing through the filtering medium. A flow director is positioned in the housing adjacent the first end of the filter element for directing the second portion of the heated fluid discharged from the passageway toward the first end of the filter element. A pump is also connected to the housing for creating a low pressure condition in the housing while the fluid passes through the filter element.

Another embodiment of the present invention involves providing a method for regenerating a filter including a housing and a filter element, which is mounted in the housing and has a first end, a second end, a filtering medium therein between the first and second ends, and a passageway extending therethrough between the first and second ends. More particularly, the method includes the steps of introducing a heated fluid to the housing adjacent the second end of the filter element, transmitting a first portion of the fluid through the second end of the filter element and discharging the first portion of the fluid from the filter element through the first end of the filter element, transmitting a second portion of the fluid through the passageway toward the first end of the filter element such that the second portion of the fluid bypasses the filtering medium, directing the second portion of the heated fluid discharged from the passageway toward the first end of the filter element, and discharging the fluid from the housing after the fluid has passed through the filter element. The method also involves the step of creating a low pressure condition in the housing while the fluid passes through the filter element.

### BRIEF DESCRIPTION OF THE DRAWINGS

For a more complete understanding of the present invention, reference is made to the accompanying drawings, in which:

FIG. 1 is a cross-sectional view of a filtration system constructed in accordance with the present invention;

FIG. 2 is a cross-sectional view, taken along section line 2-2 and looking in the direction of the arrows, of the filtration system shown in FIG. 1;

FIG. 3 is a bottom perspective view of a fluid flow-director of the filtration system shown in FIG. 1; and

FIG. 4 is a schematic view of the filtration system shown in FIG. 1, illustrating a flow path of heated fluid during the performance of a regeneration cycle.

### BEST MODE FOR CARRYING OUT THE INVENTION

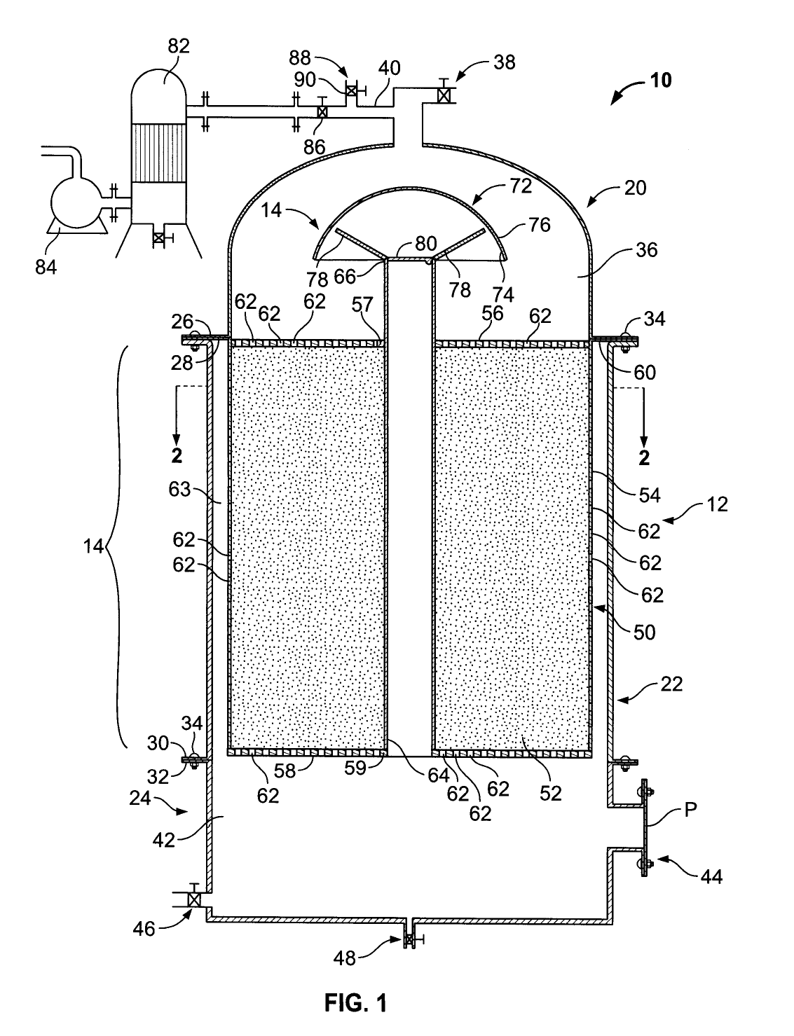

Referring to FIGS. 1, 2 and 4, there is shown a filtration system 10 constructed in accordance with the present invention. The filtration system 10 includes a housing 12, a filter unit or element 14, a fluid flow director 16 and a heated fluid generator 18. More particularly, the housing 12 is sized and shaped so as to contain the filter unit 14 and the flow director 16 and includes a domed-shape upper section 20, a cylindrically shaped middle section 22, and a pan-shaped lower section 24. The upper, middle and lower sections 20, 22, 24 have a flanged end 26, a pair of flanged ends 28, 30 and a flanged end 32, respectively. Each of the flanged ends 26, 28, 30, 32 is removably attached in a substantially fluid-tight manner by a fastener 34 to a corresponding one of the flanged ends 26, 28, 30, 32 so as form the housing 12. The upper section 20 defines an upper cavity 36 and includes an inlet 38 and an outlet 40, while the middle and lower sections 22, 24 cooperate with one another so as to define a lower cavity 42. The lower section 24 is provided with an inlet 44 for receiving heated fluid from the generator 18 during the performance of a regeneration cycle, as well as an outlet 46 and a drain 48 for purposes to be discussed hereinafter.

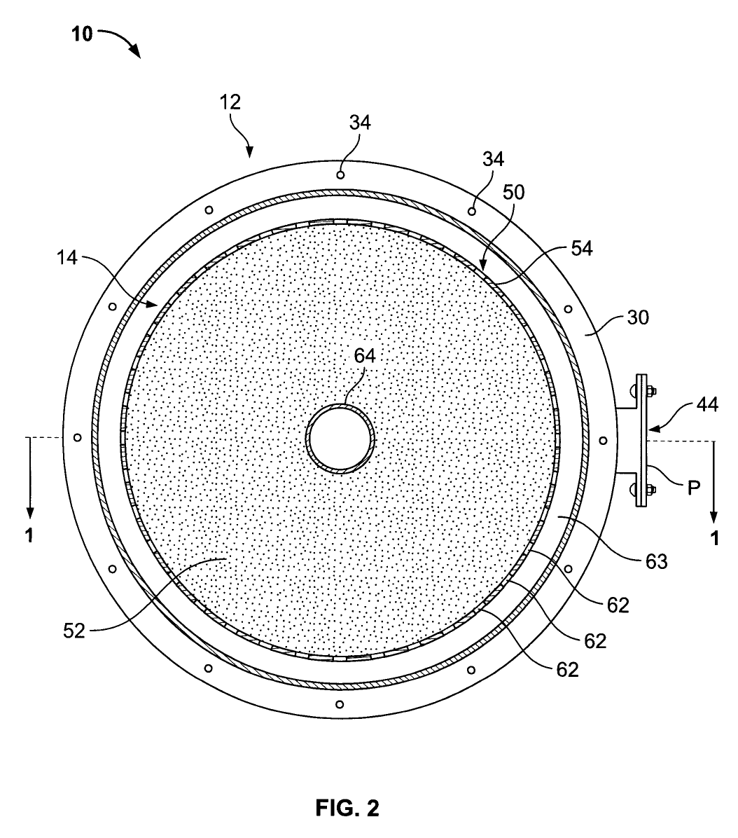

The filter unit 14 includes a cartridge or canister 50 (see FIGS. 1 and 2), which contains filter media 52 (e.g., activated carbon, sand, clay, silica, fused alumina, garnet, zircon, ilmenite, activated silica, free carbon, zeolite, ceramics or other filter media suitable for regeneration by heat) for removing particulates, contaminants and/or other undesirable substances from fluid flowing therethrough. The canister 50 is provided with a cylindrical wall 54, top and a bottom plates 56, 58, which are welded to the cylindrical wall 54, and a flange 60, which extends radially outwardly from an upper end of the cylindrical wall 54. The flange 60 is mounted between the flanges 26, 28 of the upper and middle section 20, 22, respectively, of the housing 12 for securely supporting the canister 50 within the lower cavity 42. Each of the cylindrical wall 54, the top plate 56 and the bottom plate 58 is provided with a plurality of perforations 62 so as to allow passage of fluid therethrough. In addition, the top and bottom plates 56, 58 are equipped with openings 57, 59, respectively. Moreover, the cylindrical wall 54 has a diameter smaller than that of the middle and/or lower section 22, 24 of the housing 12 such that an annular space 63 is formed between the canister 50 and the housing 12 for purposes to be discussed hereinbelow.

With reference to FIG. 1, a tube 64 extends through the canister 50 for facilitating passage of heated fluid from the lower cavity 42 to the upper cavity 36 during the performance of a regeneration cycle. More particularly, the tube 64 extends from the opening 59 of the bottom plate 58 through the opening 57 of the top plate 56 and terminates at an upper end 66, which is located above the top plate 56. As a result, the tube 64 defines a passageway extending through the canister 50. The tube 64 and the canister 50 can be constructed as a single unit (e.g., the tube 64 can be welded to the top and bottom plates 56, 58).

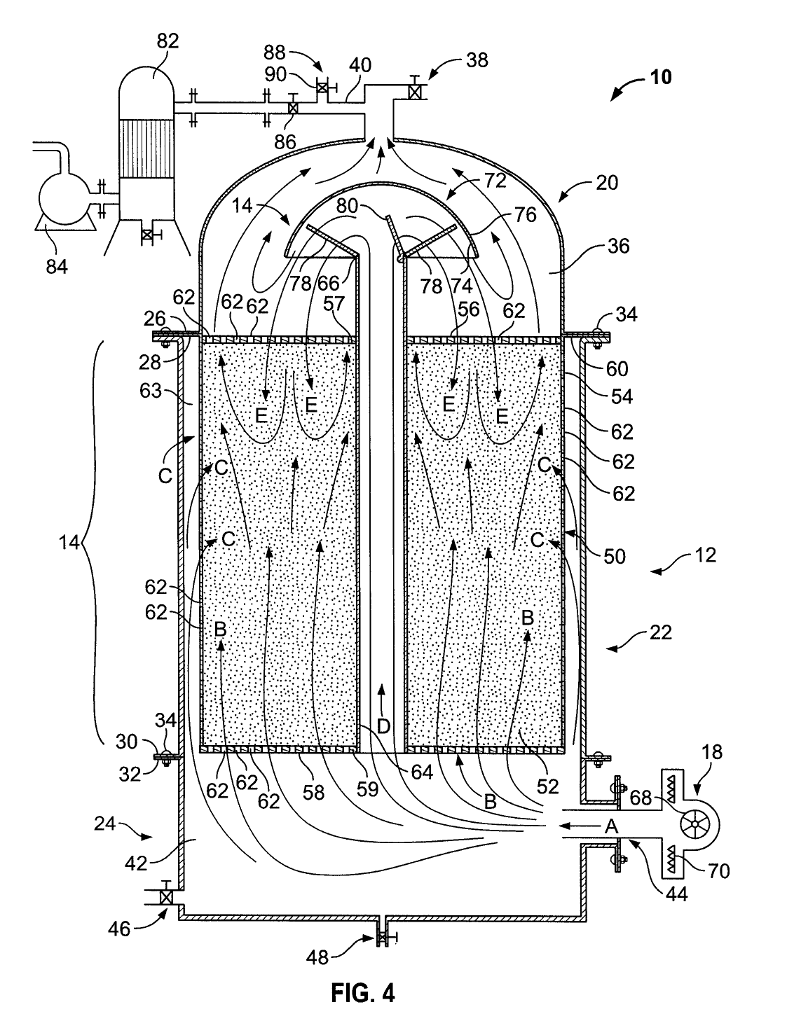

Referring back to FIG. 4, the generator 18 can be constructed in any conventional manner so as to generate a stream of heated fluid suitable for regenerating the filter unit 14. For instance, the generator 18 can be equipped with a blower 68 and a heater 70 mounted externally relative to the housing 12 for generating and introducing the stream of heated fluid into the lower cavity 42 of the housing 12 through the inlet 44. The fluid can be heated to any conventional temperature (e.g., 150° C.-450° C.) suitable for regenerating the filter unit 14 by causing contaminants to evaporate, burn, etc.

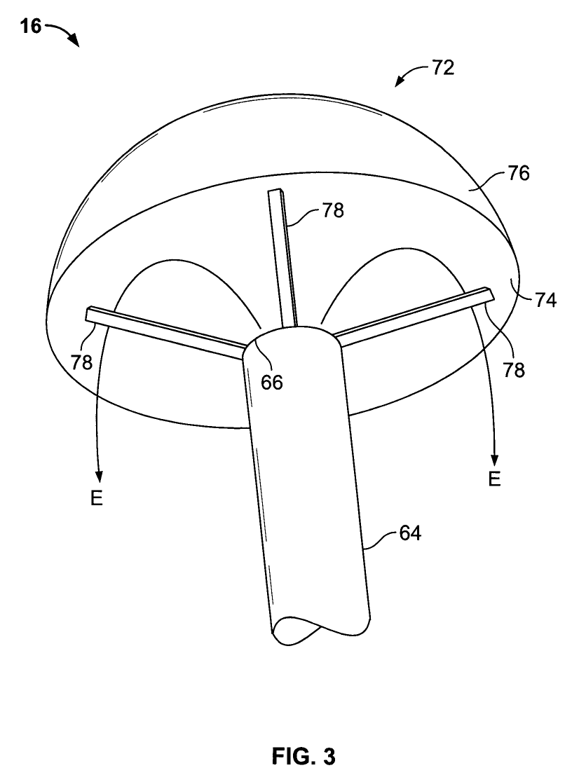

Now Referring to FIGS. 1 and 3, the flow director 16 is positioned in the upper cavity 36 of the housing 12 and includes a domed-shaped baffle 72 having inner and outer surfaces 74, 76. Struts 78 extend from the upper end 66 of the tube 64 to the inner surface 74 of the baffle 72 for supporting the baffle 72 above the upper end 66 of the tube 64. A check valve 80 can be provided adjacent the upper end 66 of the tube 64 purposes to be discussed hereinbelow. The flow director 16 can be fabricated from any conventional materials, such as stainless steel.

With reference to FIG. 1, the filtration system 10 includes a condenser 82 and a vacuum pump 84 connected to the condenser 82. The condenser 82 is connected to the outlet 40 of the housing 12 via a vacuum valve 86. An exit port 88 is also connected to the outlet 40 via an outlet valve 90.

Prior to the initiation of a filtration cycle of the filtration system 10, a plate P is attached to the inlet 44 in a fluid-tight manner (see FIG. 1) so as to prevent liquid discharge therethrough. Liquid or fluid (not shown) to be filtered flows into the upper cavity 36 of the housing 12 through the inlet 38. The baffle 72 distributes the liquid flowing from the inlet 38 substantially evenly onto the top plate 56 of the canister 50 and inhibits the liquid from entering the tube 64. The liquid then flows into the canister 50 through the perforations 62 of the top plate 56 and thereafter passes through the filter media 52, whereby impurities and other undesirable substances are removed from the liquid and are retained in the filter media 52. The fluid flows out of the canister 50 through the perforations 62 of the cylindrical wall 54 and the bottom plate 58 and is then discharged from the lower cavity 42 through the outlet 46 of the housing 12. The check valve 80 is configured to prevent the unfiltered liquid from bypassing the filter media 52 through the tube 64. During the filtration cycle, the outlet 40 and the drain 48 are in their closed state via valves.

When regeneration of the filter media 52 is required, the plate P is removed from the inlet 44, and the generator 18 is connected to the inlet 44. The inlet 38 is also closed so as to prevent fluid to be filtered from entering the housing 12. The drain 48 is then opened so as to discharge liquid remaining in the housing 12, and the outlet valve 90 is moved to its open position so as to open the exit port 88 to the atmosphere. With the vacuum valve 86 closed, the generator 18 is activated so as to generate and inject a stream of fluid or gas (e.g., steam, air, inert gases, such as nitrogen, or other suitable gases) having a desired temperature (e.g., 150° C.-450° C.) into the lower cavity 42 of the housing 12 through the inlet 44 (see arrow A in FIG. 4). When injected into the housing 12, a portion of the heated gas flows into the canister 50 through the perforations 62 provided in the bottom plate 58 (see arrows B in FIG. 4). Likewise, a portion of the heated gas flows into the annular space 63 and penetrates into the canister 50 through the perforations 62 of the cylindrical wall 54 (see arrows C in FIG. 4). The heated gas flowing into the canister 50 through the perforations 56 of the bottom plate 58 and the cylindrical wall 54 passes through the filter media 52 and exits the canister 50 through the upper plate 56.

The remaining portion of the heated gas entering the lower cavity 42 flows toward the upper cavity 36 through the tube 64 (see arrows D in FIG. 4). The check valve 80 is configured so as to permit the heated gas to pass from the lower cavity 42 to the upper cavity 36. After passing upwardly through the check valve 80, the heated gas is deflected in a downward direction by the baffle 72 of the flow director 16 (see arrows E in FIG. 4) toward the upper plate 56 of the canister 50. Thereafter, the heated gas at least partially flows into the canister 50 through the perforations 62 of the upper plate 56 (or comes in contact with the upper plate 56) so as to heat and thereby regenerate the filter media 52 located adjacent the upper plate 56. The heated gas entering the canister 50 through the upper plate 56 is eventually re-directed upwardly, exits the canister 50 and is discharged from the upper cavity 36 through the port 88 together with the rest of the gas.

When the temperature inside the housing 12 reaches a desired level (e.g., 150° C.-450° C.), the outlet valve 90 is closed, and the vacuum valve 86 is opened. The pump 84 is then activated such that the gas is drawn from the housing 12 into the condenser 82. As the gas having a high temperature passes through the canister 50, impurities and/or chemicals trapped in the filter media 52 vaporize and are removed from the filter media 52. Once the gas is withdrawn from the housing 12 and passes through the condenser 82, at least some of the vaporized impurities and/or chemicals condense and are removed from the gas. The pump 84 is left activated until the completion of the regeneration cycle. Because the pump 84 creates a low pressure condition within the housing 12, a lower heat level is required to vaporize impurities and/or chemicals from the filter media 52, thereby facilitating the energy-efficient and faster regeneration of the filter media 52.

As mentioned above, the outlet valve 90 is opened at the beginning of the regeneration cycle so as to allow the venting of the heated gas from the housing 12. Alternatively, depending upon the type of fluid utilized for regeneration (e.g., steam and gas other than air), the outlet valve 90 can be in its closed position such that the heated gas can accumulate and remain in the housing 12 longer so as to facilitate the heating of the filter media 52. When a different heat source (e.g., a gas burner) is utilized as the heated gas generator 18, the outlet valve 90 should preferably be opened at the initiation of the regeneration cycle and then closed once the temperature within the housing 12 reaches a desired level.

It should be noted that the present invention provides numerous advantages over the prior art. Due to the provision of the tube 64 and the flow director 16, heated gas (having high thermal energy) can be applied directly to the filter media 52 located proximate the upper plate 56 of the canister 50 (hereinafter “the upper filter media 52”), thereby facilitating the regeneration of the filter element 14. Since the upper filter media 52 would become more densely clogged with impurities, in comparison to other areas of the filter media 52, the heated gas flowing through the tube 64 is particularly effective in improving the regeneration of the filter media 52 proximate the top plate 56. The flow path of the heated fluid through the annular space 63, and the perforations 62 of the cylindrical wall 54, also contributes to improving the regeneration of the filter media 52. In this manner, the duration and frequency of the regeneration cycle can be minimized, thereby reducing the fuel consumption of the generator 18 and hence minimizing the fuel operating costs of the filtration system 10.

It should be noted that the present invention can have numerous variations and modifications. For instance, the flow deflector 72 can be provided with a different shape or can be removably attached to the tube 64. The tube 64 can also be provided with perforations such that some of the heated gas traveling therethrough from the lower cavity 42 toward the upper cavity 36 can seep into the canister 50 to facilitate regeneration of the filter media 52 located proximate the tube 64.

The canister 50 can be constructed in many different ways. For instance, the tube 64 can be removably attached to the canister 50 to allow the canister 50 to be replaced independently of the tube 64. In this regard, the tube 64 can be fabricated as a unit separate from the canister 50, while the canister 50 can be formed with a cylindrical central tube for removably receiving the tube 64. In such circumstances, the tube 64 and the deflector 72 can be supported within the filter housing 12 by a separate supporting mechanism (e.g., a screen support mounted below the canister 50 and engaging the tube 64). The canister 50 can also be fabricated such that the upper and lower plates 56, 58 are releasably attached thereto so as to allow replenishment of filter media.

The heated fluid generator 18 may also be modified or replaced with a conventional heating mechanism. For instance, the heated fluid generator 18 may be located partially or completely within the housing 12 of the filtration system 10. In addition, the heater 68 may utilize electric resistance, petroleum base fuel, or any other energy source. The heated fluid generator 18 may also be in the form of gas burner.

It will be understood that the embodiment described herein is merely exemplary and that a person skilled in the art may make many variations and modifications without departing from the spirit and scope of the invention. All such variations and modifications, including those discussed above, are intended to be included within the scope of the invention, as defined in the appended claims.

1. A filter, comprising a housing; a filter element mounted in said housing and having a first end and a second end, said filter element including a filtering medium therein between said first and second ends and a passageway extending therethrough between said first and second ends; a generator sized and shaped so as to be connected to said housing for introducing a heated fluid to said housing adjacent said second end of said filter element for regenerating said filter element, said second end of said filter element being constructed so as to permit a first portion of the heated fluid to pass therethrough and flow toward said first end of said filter element, said passageway being constructed so as to allow a second portion of the heated fluid to flow from said second end of said filter element to said first end of said filter element without passing through said filtering medium; and a flow director positioned in said housing adjacent said first end of said filter element for directing the second portion of the heated fluid discharged from said passageway toward said first end of said filter element.

2. The filter of claim 1, wherein said filter element includes a tube extending therethrough, said tube defining said passageway.

3. The filter of claim 2, wherein said tube has an end located between said first end of said filter element and said housing, said flow director being supported from said end of said tube.

4. The filter of claim 3, wherein said tube projects from said first end of said filter element toward said housing and terminates at said end of said tube.

5. The filter of claim 4, further characterized by a plurality of struts for mounting said flow director to said end of said tube.

6. The filter of claim 3, wherein said end of said tube is sized and shaped so as to discharge the second portion of the heated fluid transmitted through said tube from said second end of said filter element.

7. The filter of claim 3, wherein said tube includes a check value mounted to said end of said tube.

8. The filter of claim 2, wherein said filter element includes a first plate, which is located at said first end of said filter element, a second plate, which is located at said second end of said filter element, and an cylindrical wall, which extends between said first and second plates.

9. The filter of claim 8, wherein said tube extends from said second plate of said filter element and terminates at an end located between said first plate and said housing.

10. The filter of claim 9, wherein said flow director is mounted to said end of said tube.

11. The filter of claim 10, wherein each of said first and second plates includes a plurality of perforations for permitting the first portion of the heated fluid therethrough, said cylindrical wall including a plurality of perforations for permitting a third portion of the heated fluid therethrough, said tube being unperforated.

12. The filter of claim 1, wherein said generator is constructed so as to be removably attached to said housing.

13. The filter of claim 12, wherein said generator includes a heater and a blower.

14. The filter of claim 13, wherein said heater is configured to generate the heated fluid having a temperature ranging from about 150° C. to about 450° C.

15. The filter of claim 1, wherein said filtering medium includes a filtering medium selected from the group consisting of activated carbon, sand, clay, silica, fused alumina, garnet, zircon, ilmenite, activated silica, free carbon, zeolite and ceramics.

16. The filter of claim 1, further comprising a pump connected to said housing for creating a low pressure condition in said housing while the fluid passes through the filter element.

17. The filter of claim 16, further comprising a condenser connected between said housing and said pump for receiving the fluid withdrawn from said housing.

18. A filter, comprising a housing; a filter element mounted in said housing and having a first end and a second end, said filter element including a filtering medium therein between said first and second ends and a passageway extending therethrough between said first and second ends; a generator sized and shaped so as to be connected to said housing for introducing a heated fluid to said housing adjacent said second end of said filter element for regenerating said filter element, said second end of said filter element being constructed so as to permit a first portion of the heated fluid to pass therethrough and flow toward said first end of said filter element, said passageway being constructed so as to allow a second portion of the heated fluid to flow from said second end of said filter element to said first end of said filter element without passing through said filtering medium; and a pump for creating a low pressure condition in said housing while the fluid passes through said filter element.

19. The filter of claim 18, further comprising a condenser connected between said housing and said pump for receiving the fluid withdrawn from said housing.

20. A method for regenerating a filter including a housing and a filter element, the filter element being mounted in said housing and having a first end, a second end, a filtering medium therein between the first and second ends, and a passageway extending therethrough between the first and second ends, said method comprising the steps of:
introducing a heated fluid to the housing adjacent the second end of the filter element;
transmitting a first portion of the fluid through the second end of the filter element and discharging the first portion of the fluid from the filter element through the first end of the filter element;
transmitting a second portion of the fluid through the passageway toward the first end of the filter element such that the second portion of the fluid bypasses the filtering medium;
directing the second portion of the fluid discharged from the passageway toward the first end of the filter element; and
discharging the fluid from the housing after the fluid has passed through the filter element.

21. The method of claim 20, further comprising the step of creating a low pressure condition in said housing while the fluid passes through the filter element.

22. The method of claim 21, further comprising the step of passing the fluid through a condenser after the fluid has passed through the filter element.

23. A method for regenerating a filter including a housing and a filter element, the filter element being mounted in said housing and having a first end, a second end, a filtering medium therein between the first and second ends, and a passageway extending therethrough between the first and second ends, said method comprising the steps of:
introducing a heated fluid to the housing adjacent the second end of the filter element;
transmitting a first portion of the fluid through the second end of the filter element and discharging the first portion of the fluid from the filter element through the first end of the filter element;
transmitting a second portion of the fluid through the passageway toward the first end of the filter element such that the second portion of the fluid bypasses the filtering medium;
creating a low pressure condition in the housing while the fluid passes through the filter element; and
discharging the fluid from the housing after the fluid has passed through the filter element.

24. The method of claim 21, further comprising the step of passing the fluid through a condenser after the fluid has passed through the filter element.
